(19) United States
(12) Patent Application Publication
(10) Pub. No.: US 2018/0022213 A1
(43) Pub. Date: Jan. 25, 2018

(54) FUEL CAP BIB

(71) Applicant: Paul Wayne Rankin, Holladay, TN (US)

(72) Inventor: Paul Wayne Rankin, Holladay, TN (US)

(21) Appl. No.: 15/598,526

(22) Filed: May 18, 2017

Related U.S. Application Data
(60) Provisional application No. 62/366,314, filed on Jul. 25, 2016.

(51) Int. Cl. B60K 15/04

(52) U.S. Cl. CPC B60K 15/04; B60K 2015/0487

(57) ABSTRACT

A fuel cap bib for protecting aluminum fuel tanks from being scratched by hanging fuel caps during fueling is provided. The fuel cap bib is a sheet of petroleum-based fluid resistant, elastic material having a through hole dimensioned and adapted to deformed over an engaged fuel cap and yet snugly bias about the circumferential flanges the fuel cap engages. The fuel cap bib provides a protective surface between the disengaged, hanging fuel cap and the aluminum fuel tank.

### CROSS-REFERENCE TO RELATED APPLICATION

This application claims the benefit of priority of U.S. provisional application No. 62/366,314, filed 25, Jul. 2016, the contents of which are herein incorporated by reference.

### BACKGROUND OF THE INVENTION

The present invention relates to fuel tank accessories and, more particularly, to a fuel cap bib for protecting aluminum fuel tanks from being scratched by hanging fuel caps during fueling.

An aluminum fuel tank is an essential part of a semi-truck or rig. Fuel caps on semi-trucks are connected to the fuel tank with a short chain. When the cap is removed for fueling, the cap hangs along the side of the fuel tank. The aluminum tank is scratched by the cap after several fuel stops. Especially if trucks are left running unattended during the fueling process, usually winter time, wherein the vibrations from the fueling process can cause a lot of scarring on the aluminum fuel tank.

As can be seen, there is a need for a fuel cap bib for protecting aluminum fuel tanks from being scratched by hanging fuel caps during fueling, wherein the fuel cap bib is placed over the cap before it is removed, thereby when the cap is removed it rests on the fuel cap bib, preventing any scratches. Just as a polished aluminum fuel tank is an essential part to one's rig, the fuel tank bib is essential for a driver's aluminum fuel tank.

### SUMMARY OF THE INVENTION

In one aspect of the present invention, a fuel cap bib for protecting aluminum fuel tanks from being scratched by hanging fuel caps during fueling includes a sheet of petroleum-based fluid resistant elastic material extending between a first and second end; and a through hole provided inward of the first end.

In another aspect of the present invention, an apparatus for protecting the curved surface of a fuel tank immediately below a throughbore thereof includes a sheet of petroleum-based fluid resistant elastic material extending between a first and second end for approximately 12 inches, wherein said sheet has a thickness between 0.175 and 0.200 inches, wherein a width of the first end is approximately 8 inches; and a through hole provided inward of the first end by approximately 1.75 inches, wherein the through hole is centered on a longitudinal axis of said sheet, and wherein the through hole is dimensioned to both snugly engage a circumferential flange of the throughbore and be deformed around a fuel cap engaging said circumferential flange.

In yet another aspect of the present invention, method of preventing a fuel tank from being damaged by a fuel cap depending from a throughbore of the fuel tank, includes providing the immediately above-mentioned apparatus and deforming the through hole over the fuel cap engaged with said circumferential flange so as to snugly engage the through hole to an exterior surface of said circumferential flange, wherein the second end either drapes below the throughbore or forms along a portion of the fuel tank below the throughbore.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention; and

FIG. 3 is a section view of an exemplary embodiment of the present invention, taken of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fuel cap bib for protecting aluminum fuel tanks from being scratched by hanging fuel caps during fueling. The fuel cap bib is a sheet of petroleum-based fluid resistant, elastic material having a through hole dimensioned and adapted to deformed over an engaged fuel cap and yet snugly bias about the circumferential flanges the fuel cap engages. The fuel cap bib provides a protective surface between the disengaged, hanging fuel cap and the aluminum fuel tank.

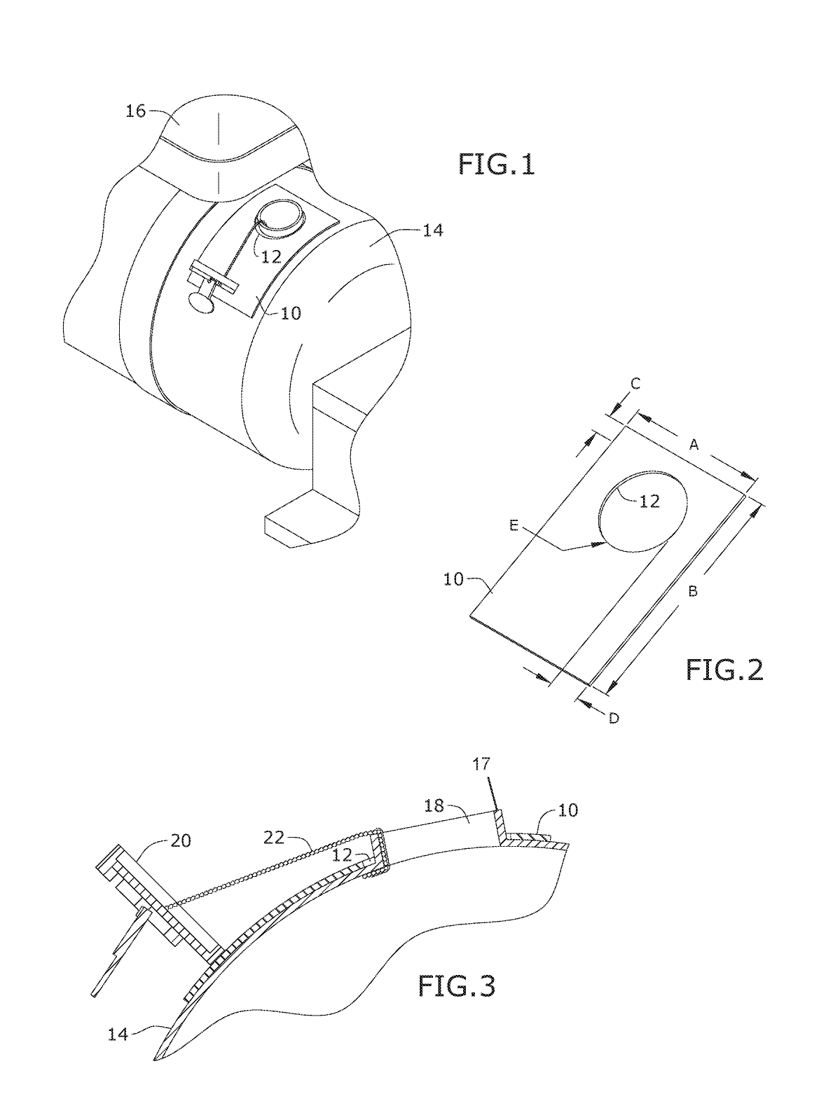

Referring to FIGS. 1 through 3, the present invention may include a fuel cap bib 10. The fuel cap bib 10 may be made from a sheet of petroleum-based fluid resistant material. The petroleum-based fluid may be diesel fuel. The sheet of material may be, but not limited to, neoprene rubber commercial grade. In certain embodiments, the sheet of material may be petroleum-based fluid absorbent. The fuel cap bib 10 can be substantially rectangular, oval, square, triangular or other geometric shapes so long as it functions in accordance with the present invention as described herein. In certain embodiments, the fuel cap bib 10 may be approximately 0.1875″ in thickness, 8.0″ in width by 12.0″ in length, wherein the width is ‘A’ and the length is ‘B’ in FIG. 2. Perimeter dimensions ‘A’ and ‘B’ define the perimeter of the sheet of material, and thus the fuel cap bib 10. The length ‘B’ needs to be sufficient to receive the hanging fuel cap. The sheet of material may be such that it either drapes along the curvature of a fuel tank 14 or forms along said curvature, as illustrated in FIGS. 1 and 3, or at least does not tend to warp upward away from said curvature.

The fuel cap bib 10 provides a through hole 12 dimensioned and adapted to snugly engage the circumferential flanges 17 of a throughbore 18 of the fuel tank 14. In certain embodiments, the through hole 12 may have a diameter of approximately 4.5″, wherein the through hole 12 is approximately 1″ from an upper width edge and approximately 1¾″ from each length edge: ‘C’ and ‘D’, respectively, as illustrated in FIG. 2. Edge dimensions, ‘C’ and ‘D’, define the position of the through hole 12 relative to the perimeter dimensions. The elastic nature of the sheet of material of the fuel cap bib 10 enables the through hole 12 to be initially stretched/deformed over and about the engaged fuel cap 20, and then be biased to snugly engage the exterior surface of said circumferential flange 17.

A method of making the present invention may include the following. An individual may cut the sheet of material of sufficient thickness to desired perimeter dimensions. Then the individual may form the through hole 12 of sufficient diameter, either by stamping or other methods, to desired edge dimensions.

A method of using the present invention may include the following. The fuel cap bib 10 disclosed above may be provided. A user, typically, the driver, would retrieve the fuel cap bib 10 from the truck side box and place one over each fuel cap 16. Most semi-trucks have 2 fuel tanks 14 and fuel both simultaneously. The user may place the fuel cap bib 10 about the circumferential flange(s) 17, then remove the fuel cap(s) 20, and begin fueling. While fueling the aluminum fuel tank 14 would be protected by the fuel cap bib 10 from scratching, as illustrated in FIGS. 1 and 3. The durable and flexible nature of the fuel cap bib 10 enables easy and space-economical storage between uses.

It should be understood, of course, that the foregoing relates to exemplary embodiments of the invention and that modifications may be made without departing from the spirit and scope of the invention as set forth in the following claims.

What is claimed is:

1. An apparatus, comprising:
a sheet of petroleum-based fluid resistant elastic material extending between a first and second end; and
a through hole provided inward of the first end.

2. The apparatus of claim 1, wherein said sheet has a thickness between 0.175 and 0.200 inches.

3. The apparatus of claim 1, wherein the through hole has a diameter of approximately 4.5 inches.

4. The apparatus of claim 1, wherein the through hole is symmetrically disposed approximately 1.75 inches from the first end.

5. The apparatus of claim 1, wherein a longitudinal distance between the first and second ends is approximately 12 inches.

6. The apparatus of claim 1, wherein a width of the first end is approximately 8 inches.

7. The apparatus of claim 1, wherein the petroleum-based fluid is diesel fuel.

8. An apparatus for protecting the curved surface of a fuel tank immediately below a throughbore thereof, comprising:
a sheet of petroleum-based fluid resistant elastic material extending between a first and second end for approximately 12 inches, wherein said sheet has a thickness between 0.175 and 0.200 inches, wherein a width of the first end is approximately 8 inches; and
a through hole provided inward of the first end by approximately 1.75 inches, wherein the through hole is centered on a longitudinal axis of said sheet, and wherein the through hole is dimensioned to both snugly engage a circumferential flange of the throughbore and be deformed around a fuel cap engaging said circumferential flange.

9. The apparatus of claim 8, wherein the petroleum-based fluid is diesel fuel.

10. The apparatus of claim 8, wherein the through hole has a diameter of approximately 4.5 inches.

11. A method of preventing a fuel tank from being damaged by a fuel cap depending from a throughbore of the fuel tank, comprising the step of:
providing the apparatus of claim 9; and
deforming the through hole over the fuel cap engaged with said circumferential flange so as to snugly engage the through hole to an exterior surface of said circumferential flange, wherein the second end either drapes below the throughbore or forms along a portion of the fuel tank below the throughbore.
